(19) United States
(12) Patent Application Publication
(10) Pub. No.: US 2011/0050638 A1
(43) Pub. Date: Mar. 3, 2011

(54) TOUCH SENSOR DEVICE AND THE METHOD OF SWITCHING OPERATION MODE THEREOF

(75) Inventor: Bang-Won Lee, Yongin-si (KR)

(73) Assignee: ATLAB INC., Yongin-si (KR)

(21) Appl. No.: 12/991,061

(22) PCT Filed: May 23, 2008
(86) PCT No.: PCT/KR08/02904

§ 371 Date: Nov. 4, 2010

(51) Int. Cl. G06F 3/045

(52) U.S. Cl. 345/174; 178/18.06

(57) ABSTRACT

Provided are a touch sensor device and a method of switching an operation mode in the touch sensor. The touch sensor device includes a touch panel for receiving an input signal generated by a touch on a surface of the touch panel and generating a touch signal on the basis of a change in internal capacitance; and a touch sensor chip for receiving the touch signal, calculating touch information, generating sense data, comparing the sense data with previously stored pattern signals, and controlling the touch sensor device to perform an operation corresponding to the received input signal.

### TECHNICAL FIELD

The present invention relates to a touch sensor device, and more particularly, to a touch sensor device processing electrical signals generated by touch inputs on a touch panel and performing operations denoted by the various input signals and a method of switching an operation mode in the touch sensor device.

### BACKGROUND ART

As a type of data input device, touch pads have touch points arranged in a matrix form on a plane to detect a position that a user touches and a direction indicated by touched points, and thus are widely used in place of a mouse. There are various types of touch pads including electrical switches, capacitor-type sensors, or transistor-type sensors arranged on a plane.

Among the types, a touch panel comprising a plurality of touch pads using capacitor-typed sensors is frequently used to control movement of a cursor in a notebook computer, and so on. The surface of the touch panel is covered with an insulating layer, and vertical and horizontal lines are arranged at regular intervals under the insulating layer. Between the horizontal lines and the vertical lines, capacitors are disposed as electrical equivalent circuits. Here, the horizontal lines constitute first electrodes, and the vertical lines constitute second electrodes.

When the surface is touched by a finger, that is a conductor, a capacitance between a horizontal line and a vertical line corresponding to the touched point differs from that between other lines at a non-touched point. Therefore, the touched point can be detected by applying a voltage signal to the horizontal lines and reading a change in the capacitance of a capacitor from vertical lines.

A letter signal, a number signal, a shape signal, etc., can be input to the touch panel. Thus, the touch panel is very useful when information is frequently input, and convenience is needed. For example, conventional cellular phones provide a hot number function to simplify input of phone numbers. A hot number is shorter than a phone number and thus facilitates input of the phone number. However, since it is difficult to give meaning to a hot number, hot numbers are difficult to remember and need to be checked every time.

On the other hand, it is easy to associate meaning with a letter, a number and a shape, that is, a simple mark and shape. For example, when a user wants to input the phone number of a specific person, the user may input first consonants of the person's Korean name or nickname or a first letter of the person's English name to make a phone call, which is very convenient for memorization and use.

FIG. 1 is a block diagram of an electrical touch sensor device according to conventional art. The electrical touch sensor device comprises a touch panel 10, a touch sensor chip 20 and a Microcontroller Unit (MCU) 30. The touch panel 10 comprises a plurality of touch electrodes 10-1 to 10-N, and the touch sensor chip 20 comprises a plurality of touch sensors 20-1 to 20-N.

The touch electrodes 10-1 to 10-N arranged on the surface of the touch panel 10 inform the touch sensor chip 20 whether or not the touch electrodes 10-1 to 10-N themselves are touched. The touch sensors 20-1 to 20-N in the touch sensor chip 20 are electrically connected with the touch electrodes 10-1 to 10-N, and the MCU 30 processes a signal obtained from the touch sensor chip 20 and controls the electrical touch sensor device to perform an operation denoted by the letter, number or shape signal.

FIG. 2 is a flowchart illustrating operation of an electrical touch sensor device according to conventional art. The operation will be described below with reference to FIGS. 1 and 2.

First, pattern signals, such as a letter signal, a number signal and a shape signal, input to the touch panel 10 and operations corresponding to respective inputs to be performed in an active mode are mapped and stored in the MCU 30 (S10).

When the electrical touch sensor device in a sleeping mode begins to operate, the MCU 30 checks whether or not a human body touches the touch electrodes 10-1 to 10-N at regular intervals.

In other words, when the touch panel 10 operates at regular intervals (S20), the touch sensors 20-1 to 20-N in the touch sensor chip 20 receive touch information from the electrically connected touch electrodes 10-1 to 10-N and output electrical signals (S30).

While calculating a position of an initially touched point, a movement direction and a movement path from the electrical signals output from the touch sensor chip 20 and storing the calculated values, the MCU 30 synthesizes the calculated values to generate one piece of sense data when a touch state ends (S35).

The sense data generated in this way is compared with the letter, number and shape signals previously mapped and stored (S40). When the same signal as the sense data exists, the electrical touch sensor device is switched to an awake mode (S50), and the MCU 30 controls the electrical touch sensor device to perform an operation corresponding to an input signal (S55).

When the same signal as the sense data does not exist, the electrical touch sensor device is maintained in the sleeping mode (S15), and the MCU 30 repeatedly checks whether or not a human body touches the touch electrodes 10-1 to 10-N.

Here, when the touch sensor chip 20 does not sense a human hand touching the touch panel 10, the MCU 30 deactivates operation of the electrical touch sensor device and cuts off power supply. On the other hand, when the touch sensor chip 20 senses a human hand touching the touch panel 10, the MCU 30 activates operation of a power supply and supplies operation power to the respective components of the electrical touch sensor device.

When the electrical touch sensor device is a wireless device, its operation time is limited by its power source such as a rechargeable battery and a battery. Thus, it is important to lengthen the operation time as much as possible. However, in the electrical touch sensor device according to conventional art, the MCU 30 performs all the operations of calculating a position of an initially touched point on the touch panel 10, a movement direction and a movement path, generating sense data, comparing the sense data with stored letter, number and shape signals, and controlling the electrical touch sensor device to perform operation in the active mode, thus consuming a lot of power.

Meanwhile, to sense a touch of a human hand on the touch panel 10 in an inactive state, the power supply must be occasionally activated to drive the touch sensor chip 20 and the MCU 30. Thus, in order to increase response speed, the power supply must be frequently activated, which results in an increase in power consumption.

Therefore, in the electrical touch sensor device according to conventional art, it is necessary to implement a mechanical switch for switching from the inactive state to the awake mode. In addition, to input different types of signals, i.e., a letter signal, a number signal and a shape signal, to the only one touch panel 10, it is necessary to switch from respective input modes to the awake mode using an operation mode switch. Consequently, the electrical touch sensor device according to conventional art has a complex constitution and requires additional production cost.

### DISCLOSURE OF INVENTION

### Technical Problem

The present invention is directed to providing a touch sensor device that can perform a function of a Microcontroller Unit (MCU) of previously storing pattern signals, generating sense data from touch information of a touch panel, and comparing the stored pattern signals with the generated sense data to control operation modes without an operation mode switch.

The present invention is also directed to providing a method of switching an operation mode in the touch sensor device.

### Technical Solution

One aspect of the present invention provides a touch sensor device comprising: a touch panel for receiving an input signal generated by a touch on a surface of the touch panel and generating a touch signal on the basis of a change in internal capacitance; and a touch sensor chip for receiving the touch signal, calculating touch information, generating sense data, comparing the sense data with previously stored pattern signals, and controlling the touch sensor device to perform an operation corresponding to the received input signal.

The touch sensor chip may have: a touch sensor unit for receiving the touch signal, sensing the touch information, and outputting a change in electrical state using an electrical signal; a sense data generator for receiving the electrical signal, calculating and storing the touch information, and, when a touch state on the touch panel ends, synthesizing the stored touch information and generating and outputting the sense data corresponding to the input signal; and a sense data analyzer for previously storing the pattern signals, receiving the sense data, comparing the pattern signals with the sense data, and controlling the touch sensor device to perform the operation denoted by the input signal according to whether or not the same pattern signal as the sense data exists.

The sense data analyzer may have: a data storage for previously storing the pattern signals capable of switching the touch sensor device to an awake mode in which the operation corresponding to the received input signal is started; and a comparator for extracting the sense data at regular intervals, receiving the previously stored pattern signals, comparing the sense data with the previously stored pattern signals, and determining whether or not the same pattern signal as the sense data exists in the data storage.

The comparator may output an awake mode switch signal for performing the operation denoted by the input signal when the same pattern signal as the sense data exists in the data storage, and may wait in a pseudo sleeping mode until another input signal is input to the touch panel when the same pattern signal as the sense data does not exist in the data storage.

The comparator may output the awake mode switch signal for starting various operations without an operation mode switch to input different types of input signals, such as a letter signal, a number signal and a shape signal, to the touch panel in common use.

The input signal, the pattern signals and the sense data may be letter, number and shape signals, and the touch information may be a position of an initially touched point, a movement direction and a movement path.

The touch sensor unit may have a plurality of touch sensors electrically connected with respective touch electrodes, receiving the touch signal generated by the touch on the touch panel and delayed for a first time, receiving a delay signal obtained by delaying a reference signal for a different time from the first time, and outputting the electrical signal using a phase difference between the touch signal and the delay signal.

Each of the touch sensors may have: a reference signal generator for generating a clock signal as the reference signal; a first signal generator for receiving and delaying the reference signal for the first time regardless of whether or not an object touches the touch panel to generate a first signal; a second signal generator for receiving the reference signal, generating a second signal without delaying the reference signal when touch pad does not sense a touch of an object, and delaying the reference signal for a longer time than the first time to generate the second signal when the touch pad senses a touch of an object; and a sense signal generator for sampling and latching the second signal in synchronization with the first signal to generate a sense signal and then outputting the sense signal to outside.

The touch panel may have: a plurality of touch electrodes arranged in a matrix form on a plane, receiving the input signal and outputting the touch signal; and an insulating layer for electrically insulating the touch electrodes and forming a specific capacitance when an object touches the insulating layer.

Another aspect of the present invention provides a method of switching an operation mode in a touch sensor device having a touch panel receiving an input signal generated by a touch on a surface of the touch panel and transferring touch information to a touch sensor chip, the method comprising: a sense data generation step of receiving an input signal generated by a touch on the surface of the touch panel, calculating and storing touch information, and, when a touch state on the touch panel ends, synthesizing the stored touch information, and generating and outputting sense data corresponding to the input signal; a sense data analysis step of previously storing pattern signals, receiving the sense data, comparing the pattern signals with the sense data, and controlling the touch sensor device to perform an operation denoted by the input signal according to whether or not the same pattern signal as the sense data exists; and an operation mode switch step of outputting, at the touch sensor chip, an awake mode switch signal when the same pattern signal as the sense data exists, and maintaining a pseudo sleeping mode when the same pattern signal as the sense data does not exist.

The sense data generation step may include: a touch signal generation step of receiving the input signal and generating the touch signal on the basis of a change in internal capacitance; and a touch sensing step of sensing the touch information and outputting a change in electrical state using an electrical signal.

The sense data analysis step may include: a data storage step of previously storing the pattern signals capable of switching the touch sensor device to an awake mode in which the operation corresponding to the input signal is started; and a signal comparison step of extracting the sense data at regular intervals, receiving the previously stored pattern signals, comparing the previously stored pattern signals with the sense data, and determining whether or not the same pattern signal as the sense data exists in a data storage.

The signal comparison step may include outputting an awake mode switch signal for starting various operations without an operation mode switch to input different types of input signals, such as a letter signal, a number signal and a shape signal, to the touch panel used in common.

The operation mode switch step may include: outputting the awake mode switch signal for starting the operation denoted by the input signal and displaying a screen required for the operation on the touch panel when the same pattern signal as the sense data exists; and waiting in the pseudo sleeping mode until another input signal is input to the touch panel when the same pattern signal as the sense data does not exist.

The operation mode switch step may further include: after a specific time, determining whether or not it is possible to switch to the pseudo sleeping mode during operation; when it is possible to switch to the pseudo sleeping mode during operation, determining whether or not another touch is made on the touch panel for a specific period during operation; and when it is not possible to switch to the pseudo sleeping mode during operation, displaying a screen required for the operation denoted by the input signal on the touch panel.

Determining whether or not another touch is made may include: when it is determined that another touch is made on the touch panel for the specific period, displaying the screen required for the operation denoted by the input signal; and when it is determined that another touch is not made on the touch panel for the specific period, waiting until another input signal is input to the touch panel.

The touch sensing step may include: a reference signal generation step of generating a clock signal as a reference signal; a first signal generation step of receiving and delaying the reference signal for a first time regardless of whether or not an object touches the touch panel to generate a first signal; a second signal generation step of receiving the reference signal, generating a second signal without delaying the reference signal when a touch pad does not sense a touch of an object, and delaying the reference signal for a longer time than the first time to generate the second signal when the touch pad senses a touch of an object; and a sense signal generation step of sampling and latching the second signal in synchronization with the first signal to generate a sense signal and then outputting the sense signal to outside.

### ADVANTAGEOUS EFFECTS

In a touch sensor device according to an exemplary embodiment of the present invention, a touch sensor chip can perform functions that a Microcontroller Unit (MCU) conventionally performs, and thus power consumed for letting the touch sensor device perform various operations through a touch input on a touch panel is remarkably reduced. In addition, the touch sensor device can switch between various operations without an operation mode switch, thus facilitating system configuration and requiring low production cost.

### BRIEF DESCRIPTION OF THE DRAWINGS

FIG. 1 is a block diagram of an electrical touch sensor device according to conventional art;

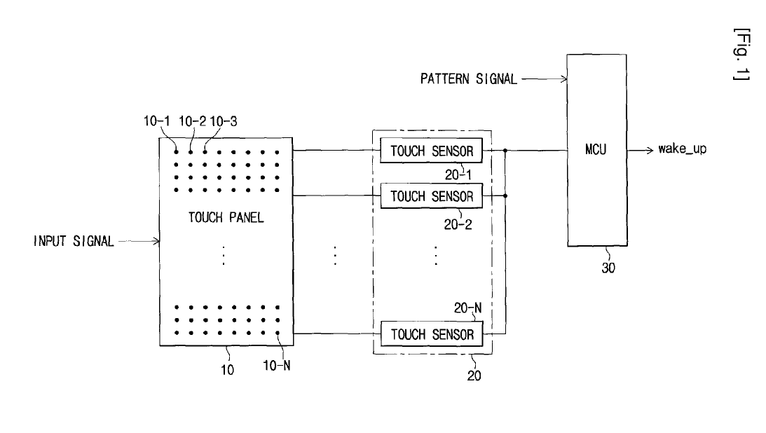

FIG. 2 is a flowchart illustrating operation of an electrical touch sensor device according to conventional art;

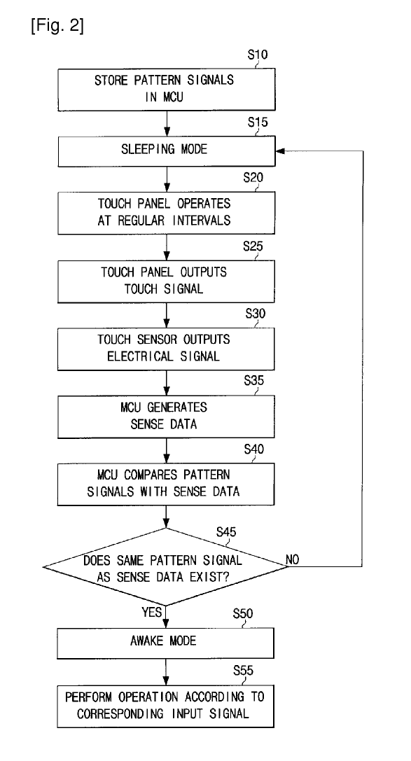

FIG. 3 is a block diagram of an electrical touch sensor device according to an exemplary embodiment of the present invention;

FIG. 4 is a block diagram illustrating a connection between one touch electrode in a touch panel and one touch sensor in a touch sensor unit; and

FIG. 5 is a flowchart illustrating operation of an electrical touch sensor device according to an exemplary embodiment of the present invention.

### MODE FOR THE INVENTION

Hereinafter, a semiconductor device and a daisy-chain-communication-mode touch sensor device according to exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

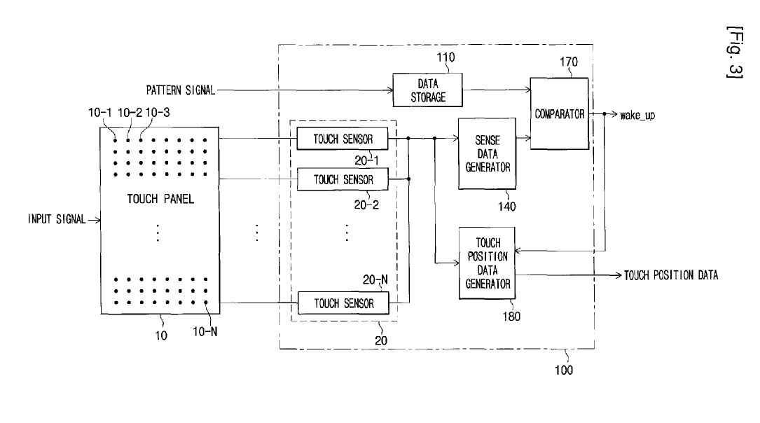

FIG. 3 is a block diagram of an electrical touch sensor device according to an exemplary embodiment of the present invention, having a touch panel 10 and a touch sensor chip 100. The touch panel 10 comprises a plurality of touch electrodes 10-1 to 10-N, and the touch sensor chip 100 comprises a touch sensor unit 20, a data storage 110, a sense data generator 140, a comparator 170 and a touch position data generator 180. The touch sensor unit 20 comprises a plurality of touch sensors 20-1 to 20-N.

Functions of the respective components of the electrical touch sensor device according to an exemplary embodiment of the present invention will be described below with reference to FIG. 3.

In the touch panel 10, the touch electrodes 10-1 to 10-N are arranged in a matrix form on a plane. The touch panel 10 receives an input signal, such as a letter signal, a number signal and a shape signal, and generates an electrical signal on the basis of a change in internal capacitance.

The data storage 110 previously stores pattern signals, such as a letter signal, a number signal and a shape signal, which are input to the touch panel 10 and can switch the electrical touch sensor device from a pseudo sleeping mode to an awake mode.

The touch sensors 20-1 to 20-N in the touch sensor unit 20 are electrically connected with the touch electrodes 10-1 to 10-N, and the touch sensor unit 20 receives the electrical signal, senses a position of an initially touched point and a movement direction and a movement path, and outputs a change in electrical state using an electrical signal.

The sense data generator 140 receives the electrical signal output from the touch sensor unit 20, calculates the position of an initially touched point, the movement direction and the movement path and stores the values. When a touch state ends, the sense data generator 140 synthesizes the stored values and generates and outputs sense data, such as a letter signal, a number signal and a shape signal, corresponding to the input signal.

The comparator 170 extracts the sense data generated from the sense data generator 140 at regular intervals and compares the pattern signals, such as a letter signal, a number signal and a shape signal, previously stored in the data storage 110 with the sense data. When the same pattern signal as the sense data exists, the comparator 170 outputs an awake mode switch signal for performing an operation denoted by the input signal. On the other hand, when the same pattern signal as the sense data does not exist, the comparator 170 waits in the pseudo sleeping mode until another input signal, such as a letter signal, a number signal and a shape signal, is input to the touch panel 10.

When the comparator 170 outputs the awake mode switch signal, the touch position data generator 180 receives the electrical signal from the touch sensor unit 20, and generates and outputs touch position data, which denotes touch position coordinates, in response to the awake mode switch signal of the comparator 170.

Here, the pseudo sleeping mode denotes a state in which the touch sensor unit 20 of the electrical touch sensor device according to an exemplary embodiment of the present invention keeps operating at lower frequency than in normal operation, and other blocks 110, 140, 170 and 180 are maintained in a sleeping mode, unlike conventional art in which all blocks of an electrical touch sensor device operate in an active state after switching from the sleeping mode to the awake mode.

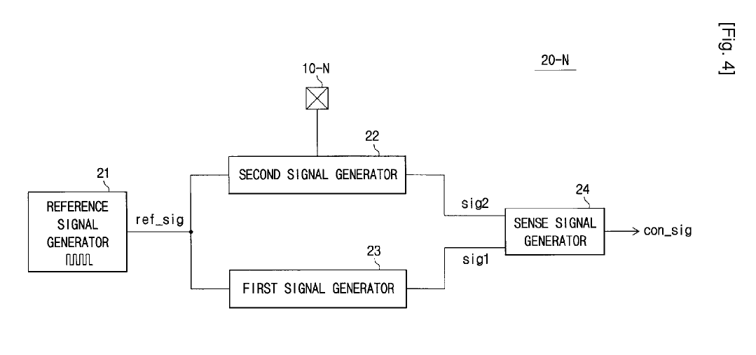

FIG. 4 is a block diagram illustrating a connection between one touch electrode in a touch panel and one touch sensor in a touch sensor unit, comprising a touch electrode 10-N, a reference signal generator 21, a first signal generator 23, a second signal generator 22 and a sense signal generator 24.

Functions of the respective blocks will be described below.

The reference signal generator 21 generates a reference signal ref_sig as a clock signal and applies the reference signal to the first and second signal generators 23 and 22.

The first signal generator 23 keeps delaying the reference signal ref_sig for a first time regardless of whether or not an object touches the touch panel to generate a first signal sig1.

The second signal generator 22 has the touch electrode 10-N touched by an object. When an object is not in contact with the touch electrode 10-N, the second signal generator 22 generates a second signal sig2 without delaying the reference signal ref_sig. On the other hand, when an object is in contact with the touch electrode 10-N, the second signal generator 22 delays the reference signal ref_sig for a longer time than the first time to generate the second signal sig2.

In other words, the second signal generator 22 generates the second signal sig2 having a phase leading that of the first signal sig1 when an object is not in contact with the touch electrode 10-N, and generates the second signal sig2 having a phase lagging that of the first signal sig1 when an object is in contact with the touch electrode 10-N.

Here, the object may be any object having a specific capacitance, for example, the human body in which a large amount of charge can be accumulated.

The sense signal generator 24 samples and latches the second signal sig2 in synchronization with the first signal sig1 to generate a sense signal con_sig.

Here, the output of the reference signal generator 21 may have different frequencies according to operation modes of the touch sensor chip 100. For example, the output may have a low frequency before the touch sensor chip 100 switches to the awake mode, and may have a high frequency after the touch sensor chip 100 switches to the awake mode.

Since an intended touch may not be instantly made, the example allows the electrical touch sensor device to respond to a high-speed touch after switching to the awake mode. Before switching to the awake mode, the example reduces power consumption and prevents malfunction caused by an unintended touch.

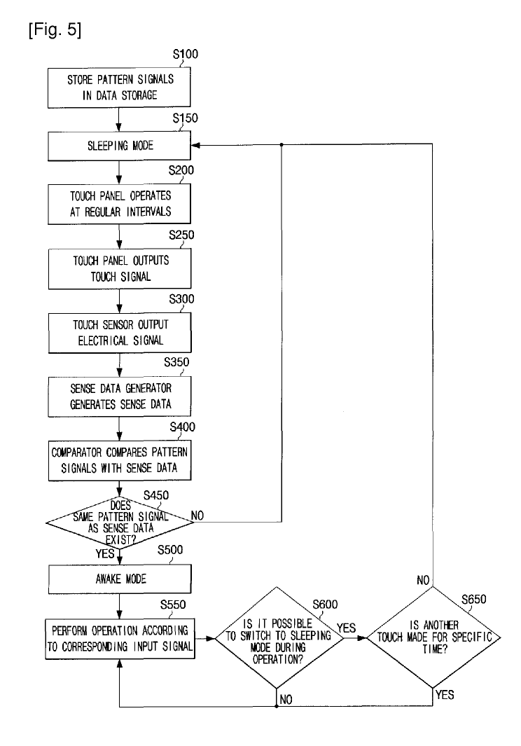

FIG. 5 is a flowchart illustrating operation of an electrical touch sensor device according to an exemplary embodiment of the present invention. Operation of the electrical touch sensor device according to an exemplary embodiment of the present invention will be described below with reference to FIGS. 3 to 5.

As an example, an electrical touch sensor device employed in a car navigator, which performs audio operations such as receiving of radio broadcasting programs, video operations such as receiving of television broadcasting programs, and traffic information guide operations by a touch of a driver's finger on the touch panel 10, will be described.

First, the data storage 110 previously stores pattern signals, such as a letter signal, a number signal and a shape signal, input to the touch panel 10 and capable of switching the electrical touch sensor device from the pseudo sleeping mode to the awake mode (S100).

For example, assuming that a letter signal of “

[symbol]

” shape is an input for letting the electrical touch sensor device perform a traffic information guide operation, a pattern signal of “̂” shape is an input for letting the electrical touch sensor device perform an audio operation, a letter signal of “V” shape is an input for letting the electrical touch sensor device perform a video operation, and a pattern signal of “ ” shape is an input for letting the electrical touch sensor device continue a previous operation, the letter and pattern signals are stored in the data storage 110.

When a driver inputs a pattern of “̂” shape on the touch panel 10 by finger touch to listen to a radio broadcast while driving, touch electrodes at a point where touch of the driver's finger starts and along the movement of the pattern of “̂” shape among the touch electrodes 10-1 to 10-N in the touch panel 10 generate touch information on an initially touched position, a movement direction and a movement path as a touch signal on the basis of a change in internal capacitance (S250).

The touch sensor unit 20 receives an electrical signal caused by a touch of the driver's finger on the touch panel 10 and delayed for a specific time, and outputs the touch signal using a phase difference between the electrical signal and another electrical signal obtained by delaying a reference signal for another specific time. Here, the touch sensor unit 20 senses the position of an initially touched point, the movement direction and the movement path and outputs a change in electrical state using an electrical signal (S300).

The sense data generator 140 receives the electrical signal output from the touch sensor unit 20, calculates and stores the position of an initially touched point, the movement direction and the movement path, and when a touch state ends, synthesizes the stored values, and generates and outputs sense data of “̂” shape, that is, a pattern signal corresponding to the input signal (S350).

The comparator 170 compares the sense data of “̂” shape generated from the sense data generator 140 with the letter signal of “

[symbol]

” shape, the pattern signal of “̂” shape, the letter signal of “V” shape and the pattern signal of “-” shape previously stored in the data storage 110 (S400).

When the comparator 170 outputs an awake mode switch signal, the touch position data generator 180 receives the electrical signal from the touch sensor unit 20, and generates and outputs touch position data, which denotes touch position coordinates, in response to the awake mode switch signal of the comparator 170.

Since the same pattern signal of “̂” shape as the sense data exists in the data storage 110, the comparator 170 outputs the awake mode switch signal for performing an audio operation denoted by the corresponding input signal, and the touch position data generator 180 derives touch position coordinates from the output of the touch sensor unit 20 in response to the awake mode switch signal (S500). On the other hand, when the driver inputs a pattern signal of “<” shape instead of “̂” shape to the touch panel 10 by mistake, the comparator 170 determines that the same pattern signal of “<” shape as the sense data does not exist in the data storage 110, and waits in the pseudo sleeping mode until another signal, such as a letter signal, a number signal and a shape signal, is input to the touch panel 10 without outputting the awake mode switch signal (S150).

When the awake mode switch signal for performing an audio operation denoted by the pattern signal of “̂” shape is output, an audio system in the car navigator starts operation, and a user interface related to the audio system operates, such that the touch panel displays a screen required for audio operations (S550). Here, the user interface is designed to facilitate use of various electronic devices, and icons designed to facilitate use of computers are typical examples of the user interface.

After a specific time, it is determined whether or not the car navigator enables switching to the pseudo sleeping mode during operation for the purpose of reducing power consumption, rapidly switching to another operation, and so on (S600).

When it is determined that the car navigator enables switching to the pseudo sleeping mode during operation, the touch sensor unit 20 determines whether or not another touch of the driver's finger is made on the touch panel 10 for a specific time while the audio system operates (S650). On the other hand, when it is determined that the car navigator does not enable switching to the pseudo sleeping mode during operation, the user interface related to the audio system keeps operating, and thus the touch panel 10 displays only a screen required for audio operations (S550).

When it is determined that the car navigator enables switching to the pseudo sleeping mode during operation, and the touch sensor unit 20 determines that another touch of the driver's finger is made on the touch panel 10 for a specific time while the audio system operates, the user interface related to the audio system keeps operating, and the touch panel 10 displays only the screen required for audio operations (S550). On the other hand, when the touch sensor unit 20 determines that another touch of the driver's finger is not made on the touch panel 10 for a specific time while the audio system operates, the comparator 170 waits until another input, such as a letter signal, a number signal and a shape signal, is made on the touch panel 10 (S150).

In this way, in the electrical touch sensor device according to an exemplary embodiment of the present invention, the touch sensor chip 100 performs all of the operations which a Microcontroller Unit (MCU) conventionally performs of calculating a position of an initially touched point, a movement direction and a movement path, generating sense data, comparing the sense data with stored letter, number and shape signals, and controlling the electrical touch sensor device to perform an operation in an active mode.

In other words, to input different types of signals, i.e., a letter signal, a number signal and a shape signal, to the only one touch panel 10, the touch sensor chip 100 according to an exemplary embodiment of the present invention outputs the awake mode switch signal switching the electrical touch sensor device to the awake mode for various operations of the electrical touch sensor device without an operation mode switch, thereby performing the function that an MCU conventionally performs.

Conventionally, various types of input devices have existed, which can input a letter signal, a number signal, a shape signal, etc., to the touch panel 10. However, current consumed by the touch sensor chip 100 during operation is about 5 uA per channel, which is 1/20 to 1/10 of current consumed by a conventional touch sensor chip. Thus, the replacement of the function that an MCU conventionally performs can maximize power saving.

In the above exemplary embodiment, an electrical touch sensor device applied to a car navigator is described. However, the present invention can be applied to portable communication devices, such as a cellular phone, a Personal Digital Assistant (PDA) and a Personal Media Player (PMP), and computer peripheral devices, such as a monitor and a mouse, using the touch panel 10.

For convenience, it is described above that the touch sensor unit 20 operates when the awake mode switch signal is applied, and the sense data generator 140 and the comparator 170 operate continuously. However, an operation mode can be switched by an external signal, and the sense data generator 140 and the comparator 170 can operate in the sleeping mode when there is no output from the touch sensor unit 20.

In addition, it is described above that the touch sensor unit 20 simply outputs information on whether or not a touch is made on the touch pad 10. However, the present invention can be applied to a case in which the touch sensor unit 20 outputs the value of a change in capacitance caused by a touch. In this case, it is possible to include a capacitance value in a pattern signal previously stored in the data storage 110 and use it.

While the invention has been shown and described with reference to certain exemplary embodiments thereof, it will be understood by those skilled in the art that various changes in form and details may be made therein without departing from the spirit and scope of the invention as defined by the appended claims.

1. A touch sensor device, comprising:
a touch panel for receiving an input signal generated by a touch on a surface of the touch panel and generating a touch signal on the basis of a change in internal capacitance; and
a touch sensor chip for receiving the touch signal, calculating touch information, generating sense data, comparing the sense data with previously stored pattern signals, and controlling the touch sensor device to perform an operation corresponding to the received input signal.

2. The touch sensor device of claim 1, wherein the touch sensor chip comprises:
a touch sensor unit for receiving the touch signal, sensing the touch information, and outputting a change in electrical state using an electrical signal;
a sense data generator for receiving the electrical signal, calculating and storing the touch information, and when a touch state on the touch panel ends, synthesizing the stored touch information and generating and outputting the sense data corresponding to the input signal; and
a sense data analyzer for previously storing the pattern signals, receiving the sense data, comparing the pattern signals with the sense data, and controlling the touch sensor device to perform the operation denoted by the input signal according to whether or not the same pattern signal as the sense data exists.

3. The touch sensor device of claim 2, wherein the sense data analyzer comprises:
a data storage for previously storing the pattern signals capable of switching the touch sensor device to an awake mode in which the operation corresponding to the received input signal is started; and
a comparator for extracting the sense data at regular intervals, receiving the previously stored pattern signals, comparing the sense data with the previously stored pattern signals, and determining whether or not the same pattern signal as the sense data exists in the data storage.

4. The touch sensor device of claim 3, wherein the comparator outputs an awake mode switch signal for performing the operation denoted by the input signal when the same pattern signal as the sense data exists in the data storage, and waits in a pseudo sleeping mode until another input signal is input to the touch panel when the same pattern signal as the sense data does not exist in the data storage.

5. The touch sensor device of claim 4, wherein the comparator outputs the awake mode switch signal for starting various operations without an operation mode switch to input different types of input signals, such as a letter signal, a number signal and a shape signal, to the touch panel in common use.

6. The touch sensor device of claim 5, wherein the input signal, the pattern signals and the sense data are letter, number and shape signals, and the touch information is a position of an initially touched point, a movement direction and a movement path.

7. The touch sensor device of claim 3, wherein the touch sensor unit comprises:
a plurality of touch sensors electrically connected with respective touch electrodes, receiving the touch signal generated by the touch on the touch panel and delayed for a first time, receiving a delay signal obtained by delaying a reference signal for a different time from the first time, and outputting the electrical signal using a phase difference between the touch signal and the delay signal.

8. The touch sensor device of claim 7, wherein each of the touch sensors comprises:
a reference signal generator for generating a clock signal as the reference signal;
a first signal generator for receiving and delaying the reference signal for the first time regardless of whether or not an object touches the touch panel to generate a first signal;
a second signal generator for receiving the reference signal, generating a second signal without delaying the reference signal when a touch pad does not sense a touch of an object, and delaying the reference signal for a longer time than the first time to generate the second signal when the touch pad senses a touch of an object; and
a sense signal generator for sampling and latching the second signal in synchronization with the first signal to generate a sense signal and then outputting the sense signal to outside.

9. The touch sensor device of claim 1, wherein the touch panel comprises:
a plurality of touch electrodes arranged in a matrix form on a plane, receiving the input signal, and outputting the touch signal; and
an insulating layer for electrically insulating the touch electrodes and forming a specific capacitance when an object touches the insulating layer.

10. The touch sensor device of claim 4, wherein in the pseudo sleeping mode, the touch sensor unit keeps operating at lower frequency than in normal operation, and the data storage, the sense data generator and the comparator are maintained in a sleeping mode.

11. The touch sensor device of claim 7, wherein the touch sensor unit outputs a value of a change in capacitance caused by the touch and can include the value of a change in capacitance in the previously stored pattern signals.

12. A method of switching an operation mode in a touch sensor device having a touch panel receiving an input signal generated by a touch on a surface of the touch panel and transferring touch information to a touch sensor chip, the method comprising:
a sense data generation step of receiving an input signal generated by a touch on the surface of the touch panel, calculating and storing touch information, and, when a touch state on the touch panel ends, synthesizing the stored touch information, and generating and outputting sense data corresponding to the input signal;
a sense data analysis step of previously storing pattern signals, receiving the sense data, comparing the pattern signals with the sense data, and controlling the touch sensor device to perform an operation denoted by the input signal according to whether or not the same pattern signal as the sense data exists; and
an operation mode switch step of outputting, at the touch sensor chip, an awake mode switch signal when the same pattern signal as the sense data exists, and maintaining a pseudo sleeping mode when the same pattern signal as the sense data does not exist.

13. The method of claim 12, wherein the sense data generation step comprises:
a touch signal generation step of receiving the input signal and generating the touch signal on the basis of a change in internal capacitance; and
a touch sensing step of sensing the touch information and outputting a change in electrical state using an electrical signal.

14. The method of claim 13, wherein the sense data analysis step comprises:
a data storage step of previously storing the pattern signals capable of switching the touch sensor device to an awake mode in which the operation corresponding to the input signal is started; and
a signal comparison step of extracting the sense data at regular intervals, receiving the previously stored pattern signals, comparing the previously stored pattern signals with the sense data, and determining whether or not the same pattern signal as the sense data exists in a data storage.

15. The method of claim 14, wherein the signal comparison step comprises:
outputting an awake mode switch signal for starting various operations without an operation mode switch to input different types of input signals, such as a letter signal, a number signal and a shape signal, to the touch panel in common use.

16. The method of claim 12, wherein the operation mode switch step comprises:
outputting the awake mode switch signal for starting the operation denoted by the input signal and displaying a screen required for the operation on the touch panel when the same pattern signal as the sense data exists; and
waiting in the pseudo sleeping mode until another input signal is input to the touch panel when the same pattern signal as the sense data does not exist.

17. The method of claim 12, wherein the operation mode switch step comprises:
after a specific time, determining whether or not it is possible to switch to the pseudo sleeping mode during operation;
when it is possible to switch to the pseudo sleeping mode during operation, determining whether or not another touch is made on the touch panel for a specific period during operation; and
when it is not possible to switch to the pseudo sleeping mode during operation, displaying a screen required for the operation denoted by the input signal on the touch panel.

18. The method of claim 17, wherein determining whether or not another touch is made comprises:
when it is determined that another touch is made on the touch panel for the specific period, displaying the screen required for the operation denoted by the input signal; and
when it is determined that another touch is not made on the touch panel for the specific period, waiting until another input signal is input to the touch panel.

19. The method of claim 18, wherein the input signal, the pattern signals and the sense data are letter, number and shape signals, and the touch information is a position of an initially touched point, a movement direction and a movement path.

20. The method of claim 13, wherein the touch sensing step comprises:
a reference signal generation step of generating a clock signal as a reference signal;
a first signal generation step of receiving and delaying the reference signal for a first time regardless of whether or not an object touches the touch panel to generate a first signal;
a second signal generation step of receiving the reference signal, generating a second signal without delaying the reference signal when a touch pad does not sense a touch of an object, and delaying the reference signal for a longer time than the first time to generate the second signal when the touch pad senses a touch of an object; and
a sense signal generation step of sampling and latching the second signal in synchronization with the first signal to generate a sense signal and then outputting the sense signal to outside.
